(19) United States
(12) Patent Application Publication
(10) Pub. No.: US 2008/0250192 A1
(43) Pub. Date: Oct. 9, 2008

(54) Integrating flash memory system

(75) Inventors: Khein-Seng Pua, Hsin-Chu Hsien (TW); Chung-Hsun Ma, Hsin-Chu Hsien (TW)

Correspondence Address: BACON & THOMAS, PLLC, 625 SLATERS LANE, FOURTH FLOOR, ALEXANDRIA, VA, 22314-1176, US

(73) Assignee: Phison Electronics Corp., Hsin-Chu Hsien (TW)

(21) Appl. No.: 11/730,957

(22) Filed: Apr. 5, 2007

(51) Int. Cl. G06F 13/00

(52) U.S. Cl. 711/103

(57) ABSTRACT

The present invention discloses an integrating data processing system. The system includes a master device with a host interface for processing data, at least one NAND flash memory unit having a unit interface, and a flash memory controller. For controlling access to the NAND flash memory unit, the flash memory controller is provided with a first interface connected with the host interface of the master device, and a second interface connected with the unit interface of the NAND flash memory unit. The first interface is identical to the unit interface of the flash memory and the second interface is identical to the host interface of the master device. The master device can access the NAND flash memory unit via the flash memory controller thereby facilitating to fit in with the development of new flash memory device without upgrading the original master device.

### FIELD OF THE INVENTION

The present invention relates generally to an integrating flash memory system, and more specifically, to an integrating flash memory system with dual flash memory interface and a flash memory module.

### BACKGROUND OF THE INVENTION

In recent years, a non-volatile memory has been widely used in information electronic products. A better EEPROM with faster accessing speed has been developed with advanced technique, which is called flash memory. As a non-volatile memory, a flash memory has functions of electronically writing and erasing data. Therefore, a flash memory can be broadly used in electronic products such as notebook computers and digital cameras that have been miniaturized for better portability. In fact, the developing trend of electronic products is to pursue slimmer and smaller products. Therefore, the size of flash memory has to be reduced to catch up with the trend. For this reason, a new memory card, which has small volume and fast accessing ability, has potential to dominate the small-sized memory card market. Unfortunately, not many computers have a slot available for the new memory card. On the other hand, the penetration rate of a USB slot is relatively high compared to the slot for any new memory card. Also, a portable USB flash memory apparatus is rather convenient for use because it can carry information around. Nevertheless, the flash memory is still facing a problem that it cannot be adapted to a slot for new memory card of any kind.

As shown in U.S. Pat. No. 7,062,585, it discloses a memory card for integrating the USB interface and an adaptor for the memory card. Meanwhile, an integrating memory card of the USB interface includes a memory chip inside a main body. A SD or MS control interface, a USB control interface, a controller, and a storage memory are built in the memory chip in FIG. 1. Conductive bars are electrically connected to the memory chip and stick out from one end of the main body. An adaptor for the memory card includes an insertion socket to receive a SD memory card or a MS memory card. Conductive pins are positioned inside the insertion socket to be electrically connected to the memory card. A USB connecting head is provided at the front end of the insertion socket and electrically connected to the conductive pins inside the insertion socket. When the SD memory card 10 is to be inserted into a USB slot for use, as shown in FIG. 1, the conductive bars 101 of the SD memory card 10 will have to be inserted into the insertion socket 111 of the adaptor 11. By doing so, the conductive bars 101 on the surface of the SD memory card 10 will contact the corresponding conductive pins 112 inside the insertion socket 111 and form an electrical connection. Then, the USB connecting head 113 of the adaptor 11 will be inserted into the USB slot so that conduction between the USB slot and the conductive bars 101 of the memory chip 102 can be formed by means of the conducting lines inside the USB connecting head and the conductive pins 112 inside the insertion socket 111. After that, the controller inside the SD memory chip 102 will activate the USB control interface through the interface control program in order that the SD memory card 10 can be connected to the USB slot of a master device for a smooth operation. However, the entire system fails to disclose a hint of facilitating to fit in with the development of new flash memory device without upgrading the original master device.

As shown in FIG. 2, a conventional flash memory controller 20 for intermediating between a master device 22, such as a MP3 player, and a flash memory 21 is typically equipped with a USB interface 203 and a flash memory host interface 201. To control access to the entire flash memory 21, the flash memory host interface 201 on one side of the flash memory controller 20 is coupled to a flash memory device interface 211 for transmitting interface signals, including control signal, data signal, and status signal. The USB interface 203 on the other side of the flash memory controller 20 is coupled to a host interface 221 of the master device 22 for manipulating the flash memory 21 via a flash memory control module 202 of the flash memory controller 20. The flash memory control module 202 is provided with multi-functions of error correcting operation, random reading/writing operation, data erasing operation and the like. In practice, the flash memory 21 is developing with advancing technique. To perform operations on a new flash memory, the flash memory control module 202 of the flash memory controller 20 should be updated in response to the new flash memory. Otherwise the master device 22 won't be able to access the new flash memory.

As discussed above, the prior memory card for integrating the USB interface and an adaptor fails to fit in with new advancing flash memory without upgrading the master device, and the applied flash memory is limited by the flash memory control module of the master device according to the prior art. Furthermore, the conventional flash memory controller as illustrated in FIG. 2, is equipped with a NAND flash memory host interface and others, such as a USB interface, a IDE interface, a SATA interface, or a PCI Express interface. Accordingly, applications of the conventional flash memory controller are substantially limited due to its poor compatibility with standard master devices and advancing NAND flash memory. Hence, there is a resulting need for an integrating flash memory system with a dual NAND interface flash memory controller in response to flash memory unit of any kind without making modification to the master device.

### SUMMARY OF THE INVENTION

In accordance with an aspect of the present invention, an integrating flash memory system includes a master device with a host interface for processing data, at least one NAND flash memory unit having a unit interface, and a flash memory controller having a first interface connected with the host interface of the master device, and a second interface connected with the unit interface of the NAND flash memory unit, wherein the master device can access the NAND flash memory unit via the flash memory controller.

Certainly, the first interface is identical to the unit interface of the NAND flash memory unit.

Certainly, the second interface is identical to the host interface of the master device.

Preferably, the first and the second interfaces are NAND flash memory interfaces.

Preferably, the first interface of the flash memory controller is supplied with a plurality of interface signals comprising a chip enable signal /CE, a command latch enable signal CLE, an address latch enable signal ALE, a reading enable signal /RE, a writing enable signal /WE, a write protect signal /WP, a ready/busy signal R/B, and input/output signals IO0˜7.

Preferably, the flash memory controller and the NAND flash memory unit are formed into a package in accordance with Land Grid Array (LGA), Thin Small Out-line Package (TSOP), or Chip on Board (COB) package standard.

Accordingly, the package includes 15 pins each in response to one of the plurality of interface signals.

Certainly, the flash memory controller has a pin number equal to that of the flash memory unit.

Typically, the integrating flash memory system includes a Global Positioning System (GPS), a Personal Digital Assistant (PDA), a MPEG Audio Layer III (MP3) player, and a Portable Media Player (PMP).

In accordance with another aspect of the present invention, the integrating flash memory system for use with a master device with a host interface includes at lease one NAND flash memory unit for data storage, having a unit interface; and a dual-interface flash memory controller for controlling access to the flash memory unit, having a first interface connected to the host interface of the master device, and a second interface connected with the unit interface of the NAND flash memory unit; wherein the dual-interface flash memory controller and the NAND flash memory unit are packaged into one single chip in accordance with Land Grid Array (LGA), Thin Small Out-line Package (TSOP), or Chip on Board (COB) package standard.

Certainly, the first and the second interfaces are NAND flash memory interfaces.

Typically, the first interface of the flash memory controller is supplied with a plurality of interface signals comprising a chip enable signal /CE, a command latch enable signal CLE, an address latch enable signal ALE, a reading enable signal /RE, a writing enable signal /WE, a write protect signal /WP, a ready/busy signal R/B, and input/output signals IO0˜7.

Preferably, the chip includes 15 pins each in response to one of the plurality of interface signals.

Alternatively, the integrating flash memory system includes a Global Positioning System (GPS), a Personal Digital Assistant (PDA), a MPEG Audio Layer III (MP3) player, and a Portable Media Player (PMP).

In a yet further aspect of the present invention, the integrating flash memory system comprises a flash memory controller in communication between a master device having a host interface and a NAND flash memory unit having a unit interface. The flash memory controller includes a first flash memory interface connected with the host interface of the master device; a second flash memory interface connected with the unit interface of the NAND flash memory unit; and a flash memory control module for controlling access to the NAND flash memory unit, whereby the master device can access the NAND flash memory unit via the flash memory control module.

Certainly, the first and the second interfaces are NAND flash memory interfaces.

Certainly, the first interface is identical to the unit interface of the NAND flash memory unit.

Certainly, the second interface is identical to the host interface of the master device.

Typically, the first and second interfaces of the flash memory controller are supplied with a plurality of interface signals comprising a chip enable signal /CE, a command latch enable signal CLE, an address latch enable signal ALE, a reading enable signal /RE, a writing enable signal /WE, a ready/busy signal R/B, and input/output signals IO0˜n.

Alternatively, the flash memory controller further incorporates an inner flash memory unit within the flash memory controller for extending memory capacity.

Alternatively, integrating flash memory system comprises a Global Positioning System (GPS), a Personal Digital Assistant (PDA), a MPEG Audio Layer III (MP3) player, and a Portable Media Player (PMP).

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a memory card for integrating a USB interface and an adaptor for the memory card according to the prior art;

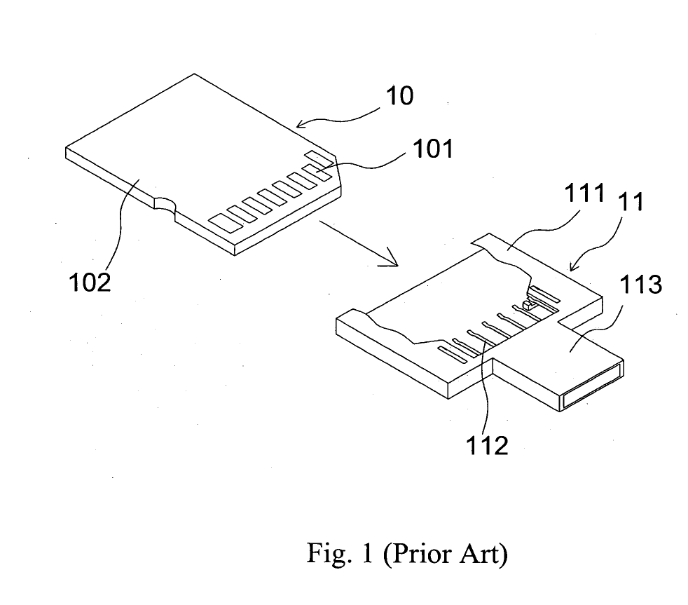

FIG. 2 illustrates an entire flash memory system controlled by a master device according to the prior art;

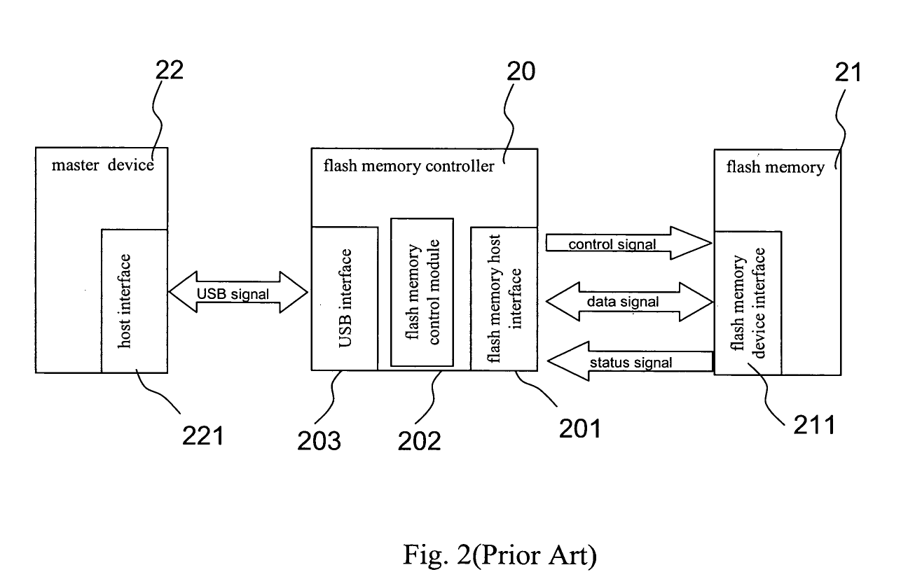

FIG. 3 illustrates one embodiment of an integrating flash memory system according to the present invention;

FIG. 4 is a schematic diagram of the flash memory controller according to the present invention;

FIG. 5 illustrates another embodiment of an integrating flash memory system according to the present invention;

FIG. 6 illustrates the integrating flash memory system packaged in accordance with 48-pin LGA standard according to the present invention;

FIG. 7 illustrates the integrating flash memory system packaged in accordance with 48-pin TSOP1 standard according to the present invention; and

FIG. 8 is another schematic diagram of the flash memory controller according to the present invention.

### DETAILED DESCRIPTION OF EMBODIMENTS

The present invention discloses an integrating flash memory system for facilitating to fit in with the development of new flash memory device without upgrading or modifying the original master device.

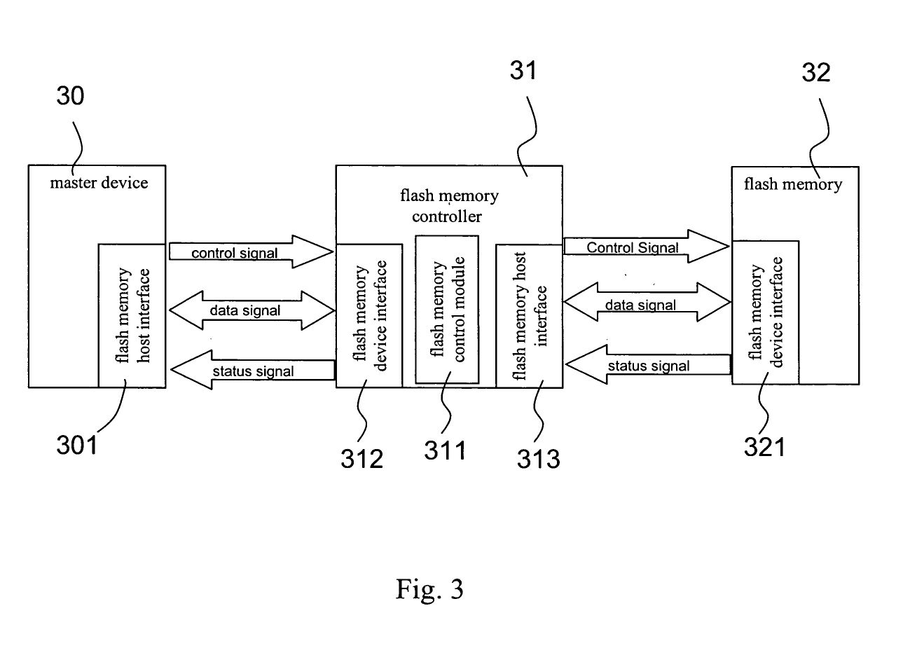

FIG. 3 illustrates one embodiment of an integrating flash memory system according to the present invention. As shown in FIG. 3, the integrating flash memory system includes a master device 30 with a flash memory host interface 301, a flash memory controller 31, and a flash memory unit 32 with a flash memory device interface 321. The master device 30 is desirably an embedded appliance, including a PDA, an MP3 player, and other resemblances. The flash memory controller 31 contains a flash memory control module 311, a flash memory device interface 312 configured to be coupled to the flash memory host interface 301 of the master device 30, and a flash memory host interface 313 configured to be coupled to the flash memory device interface 321 of the flash memory unit 32. According to the present invention, the flash memory device interface 312 of the flash memory controller 31 is identical to the flash memory device interface 321 of the flash memory 32, and the flash memory host interface 313 is identical to the flash memory host interface 301 of the master device 30. The interface of the conventional flash memory controller connected to a master device is typically a Universal Serial Bus (USB) interface and only allows USB signals transmission, while the flash memory device interface 312 of the flash memory controller 31 is a NAND flash memory interface supplied with fifteen interface signals. As shown in Table 1, these interface signals include eight-bit data/command signal (input/output signals I/O0˜7), six control signals, (i.e. a chip enable signal /CE, a command latch enable signal CLE, an address latch enable signal ALE, a reading enable signal /RE, a writing enable signal /WE, and a write protect signal /WP), and a status (ready/busy) signal R/B reporting the ready/busy status. In this manner, the master device 30 is able to manipulate the flash memory unit 32 by performing various operations, such as error-correction, bad block management, and random data reading/writing. Namely, the master device 30 accesses the flash memory unit 32 via the flash memory control module of the flash memory controller 31, instead of any original flash memory control module (not shown) of the master device 30. Namely, the flash memory device interface 312 of the flash memory controller 31 serve as the interface 321 of the flash memory unit 32, and the flash memory interface 313 works as the interface 301 of the master device 30. Without modification of any kind, the master device 30 can adapt to flash memory unit 32 through engaging the flash memory controller 31.

TABLE 1
(PIN Description for Interface Signals)

| | Pin Name | Pin Function |
|---|---|---|
| 8 Data | I/O₀~I/O₇ | DATA INPUTS/OUTPUTS |
| Signals | | The I/O pins are used to input command, address and data, and to output data during read operations. The I/O |
| | | pins float to high-z when the chip is deselected or when the outputs are disabled. |
| 6 Control | CLE | COMMAND LATCH ENABLE |
| Signals | | The CLE input controls the activating path for commands sent to the command register. When active high, |
| | | commands are latched into the command register through the I/O ports on the rising edge of the W̅E̅ signal. |
| | ALE | ADDRESS LATCH ENABLE |
| | | The ALE input controls the activating path for address to the internal address registers. Addresses are |
| | | latched on the rising edge of W̅E̅ with ALE high. |
| | C̅E̅ | CHIP ENABLE |
| | | The C̅E̅ input is the device selection control. When the device is in the Busy state, C̅E̅ high is ignored, and |
| | | the device does not return to standby mode in program or erase operation. |
| | R̅E̅ | READ ENABLE |
| | | The R̅E̅ input is the serial data-out control, and when active drives the data onto the I/O bus. Data is valid |
| | | tREA after the falling edge of R̅E̅ which also increments the internal column address counter by one. |
| | W̅E̅ | WRITE ENABLE |
| | | The W̅E̅ input controls writes to the 110 port. Commands, address and data are latched on the rising edge of |
| | | the W̅E̅ pulse. |
| | W̅P̅ | WRITE PROTECT |
| | | The W̅P̅ pin provides inadvertent program/erase protection during power transitions. The internal high volt- |
| | | age generator is reset when the W̅P̅ pin is active low. |
| 1 Status | R/ B̅ | READY/BUSY OUTPUT |
| Signal | | The R/ B̅ output indicates the status of the device operation. When low, it indicates that a program, erase or |
| | | random read operation is in process and returns to high state upon completion. It is an open drain output and |
| | | does not float to high-z condition when the chip is deselected or when outputs are disabled. |

According to the present invention, the flash memory control module 311 of the flash memory controller 31 will dominate and take over control of the flash memory unit 32 while the flash memory control module (not shown) installed in the master device 30 is disabled or removed. No further modifications to the master device to meet the changing specification of the master device or the flash memory unit are necessitated. In alternate embodiment, the flash memory controller 31 could further include an inner flash memory unit (not shown) within the flash memory controller for extending memory capacity. Likewise, the master device 30 can access the inner flash memory unit via the flash memory module 311 of the flash memory controller 31.

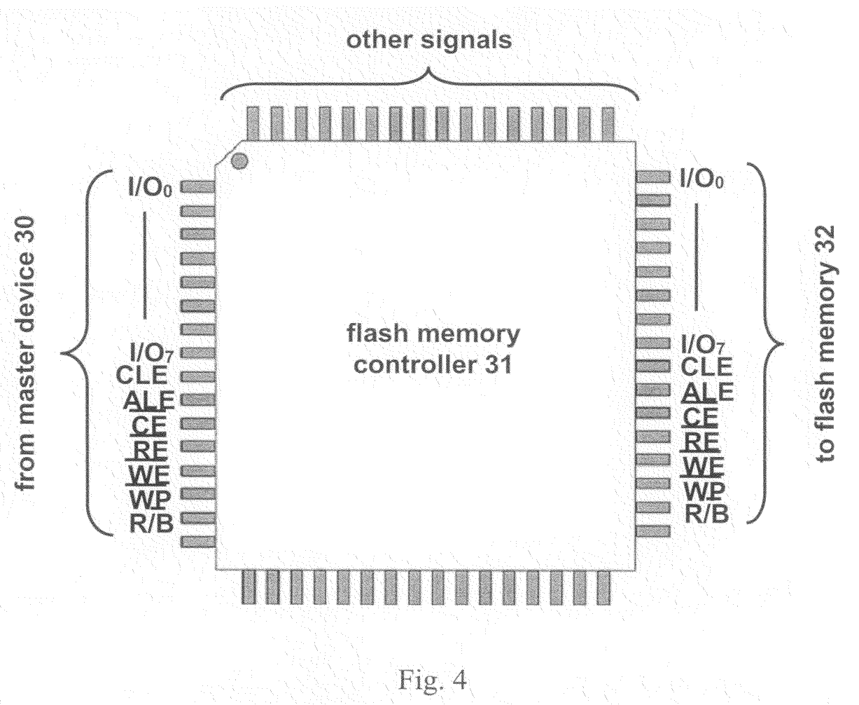

FIG. 4 illustrates an exemplary architecture of the flash memory controller 31 in FIG. 3. A flash memory controller chip is encapsulated or incorporated into a package having 64 pins for signals transmission with the master device 30 and the flash memory 32. Alternatively, the flash memory controller 31 may be packaged in different pin counts, for example, from 32 to over 200 pins with a pitch ranging from 0.4 to 1.0 mm, dependent upon the modification of manufacturers to implement the present invention. The pins are supplied with a plurality of signals shown in Table 1 above. The pin assignment of the flash memory controller 31 is not limited to any specific sequence or arrangement. As illustrated, the flash memory controller 31 is equipped with two sets of flash memory interfaces. The first set of pins is to be coupled to the master device 30, while the second set of pins is to be coupled to the flash memory 32. Both of the first and second sets of pins have eight-bit data/command signals (input/output signals I/O0˜7), six control signals, (i.e. a chip enable signal /CE, a command latch enable signal CLE, an address latch enable signal ALE, a reading enable signal /RE, a writing enable signal /WE, and a write protect signal /WP), and a status (ready/busy) signal R/B reporting the ready/busy status. Therefore, the first and second sets of pins have the identical interfaces with respect to pin assignments. However, the address or command communicated over the first set of pins is different from the address or command communicated over the second set of pins. For example, the address supplied by the master device 30 to the first set of pins is based on a logical block address (LBA) while the address supplied to flash memory 32 from the second set of pins is based on a physical address of conventional flash memories.

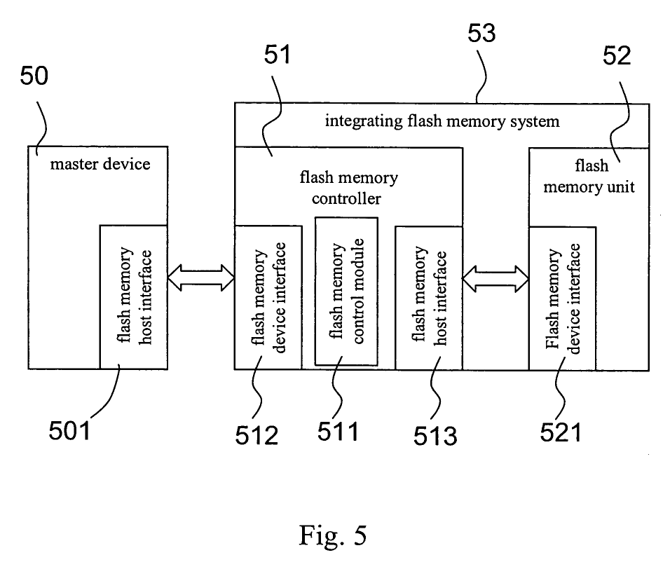

Please refer to FIG. 5. It illustrates another embodiment of an integrating flash memory system according to the present invention. As shown in FIG. 5, an integrating flash memory system 53 is provided for communication with a master device 50 with a flash memory host interface 501. The integrating flash memory 53 includes a flash memory controller 51 and a flash memory unit 52 containing a flash memory device interface 521. The flash memory controller 51 contains a flash memory control module 511 capable of being upgraded in accordance with the flash memory unit 52 (preferably a NAND flash memory). As shown in FIG. 5, the flash memory controller 51 is equipped with a flash memory device interface 512 on one side for connecting with the flash memory interface 501 of the master device 50, and a flash memory interface 513 on the other side for connecting with the flash memory device interface 521 of the flash memory unit 52. Both interfaces of the flash memory controller 51 are NAND flash memory interfaces and allow interface signals transmission.

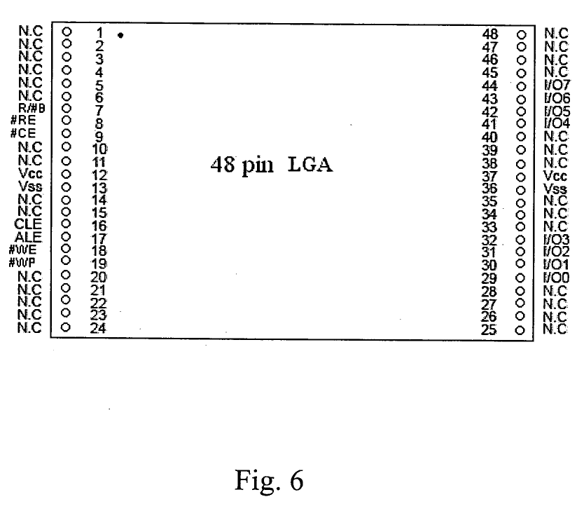

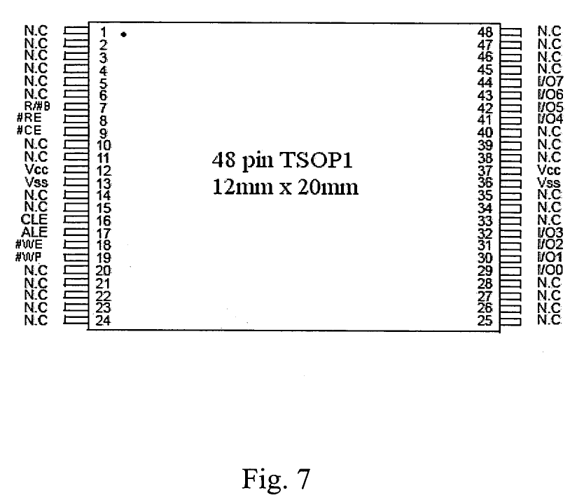

Typically, the flash memory unit 52 is packaged by Thin Small Out-line Package type 1 (TSOP1) standard, as shown in FIG. 7. The flash memory controller 51 and the flash memory unit 52 are further packaged altogether into one single chip in accordance with Land Grid Array (LGA) standard. The chip illustrated in FIG. 6 has a pin number identical to that of the original TSOP1-packaged flash memory unit 52. Each pin is in response to an interface signal. As illustrated in FIG. 6 and FIG. 7, the pins of the LGA-packaged chip are allocated in consistence with those of the original flash memory unit 32 packaged by TSOP1 standard. With this feature, no modifications are requisite for the master device 50 or the flash memory unit 32. The flash memory device interface 512 and the flash memory host interface 513 allow interface signals transmission. These interface signals includes eight data signals (input/output signals IO0˜7), six control signals (i.e. a chip enable signal /CE, a command latch enable signal CLE, an address latch enable signal ALE, a reading enable signal /RE, a writing enable signal /WE, and a write protect signal /WP), and a status signal R/B reporting the ready/busy status. The chip bridges signal transmission therebetween and enables the master device 50 to access the flash memory unit 52. With the same pin-outs of a standard NAND flash memory for the integrating flash memory system 53, there is no need to modify control method of the master device 50 when it connects to the integrating flash memory system 53. The master device 50 will regard the integrating flash memory system 53 as a standard NAND flash memory and control it in the same way.

Differentiated from the prior art as discussed above, the master device 50 accesses the flash memory unit 52 through the flash memory control module 511 of the flash memory controller 51, rather than the control module (not shown) installed within the master device 50. As the flash memory control module (not shown) installed in the master device 50 is disabled or removed, the flash memory control module 511 of the flash memory controller 51 is responsible for bridging the communication between the master device 50 and the flash memory unit 52, to facilitate data accessing or error correcting operations. In other words, the flash memory control module 511 in the present invention functions as a flash memory control module of the master device 50. The flash memory device interface 512 of the flash memory controller 51 can be regarded as the interface 521 of the flash memory unit 52, and the flash memory interface 513 works as the interface 501 of the master device 50. As expected, no further modifications to the flash memory control module of the master device to adapt to specification of flash memory unit are necessary.

Furthermore, the flash memory controller 51 and the flash memory unit 52 could be packaged into a 48-pin chip either by LGA or TSOP1 standard. Similarly, the entire integrating flash memory system 53 packaged into the chip containing the flash memory controller 51 and the flash memory unit 52 is well-suited for embedded appliances such as GPS, PDA, MP3 or multimedia players which need to access data from or to flash memory unit(s).

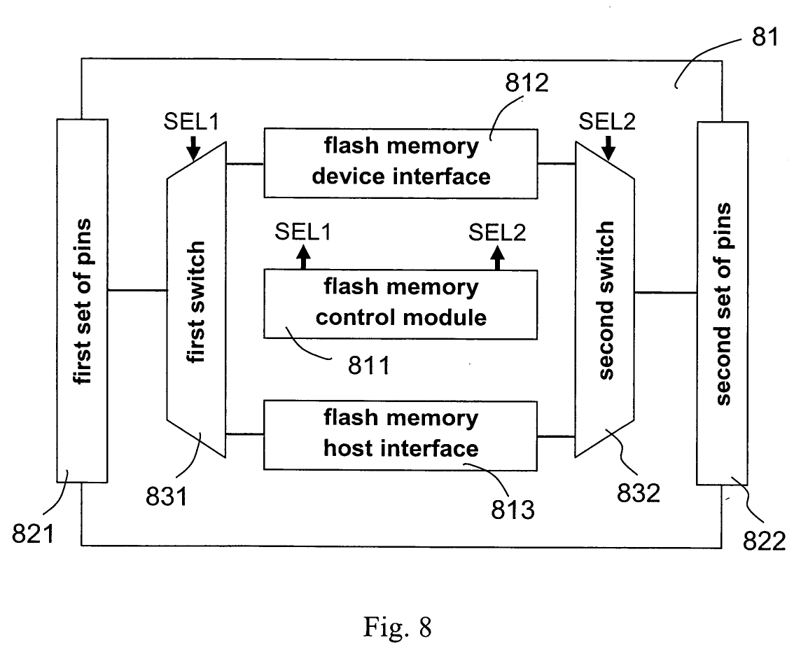

FIG. 8 illustrates another embodiment of the flash memory controller according to the present invention. The flash memory controller 81 is encapsulated into a package having a flash memory control module 811 for generating a first control signal SEL1 and a second control signal SEL2, a flash memory device interface 812, a flash memory host interface 813, a first set of pins 821, and a second set of pins 822. In this embodiment, the first set of pins 821 can be alternatively coupled to the flash memory device interface 812 or the flash memory host interface 813 by a first switch 831. Meanwhile, the second set of pins 822 can be alternatively coupled to the flash memory host interface 813 or the flash memory device interface 812 by a second switch 832. The first switch 831 is controlled by the first control signal SEL1, while the second switch 832 is controlled by the second control signal SEL2.

In summary, the present invention introduces an integrating flash memory system provided with a dual NAND interface flash memory controller. Thus, when the master device needs to apply a new flash memory device, the integrating flash memory system of the present invention is capable of facilitating to keep up with the development of new flash memory device without upgrading or modifying the master device. Keeping cost down is a rather critical issue in respect of manufacturing. The integrating flash memory system possesses a great deal of compatibility with master devices of various kinds, and is cost-effective by saving the possible expenses of upgrading and modifying the master device for new flash memory devices and substantively rectify those drawbacks of the prior art.

While the invention has been described in terms of what is presently considered to be the most practical embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. An integrating data processing system, comprising:
a master device with a host interface for processing data;
at least one NAND flash memory unit for data storage, having a unit interface; and
a flash memory controller for controlling access to the NAND flash memory unit, having a first interface connected with the host interface of the master device, and a second interface connected with the unit interface of the NAND flash memory unit;
wherein the first interface is identical to the unit interface of the flash memory and the second interface is identical to the host interface of the master device.

2. The integrating data processing system according to claim 1, wherein the first and the second interfaces are NAND flash memory interfaces.

3. The integrating data processing system according to claim 1, wherein the first interface of the flash memory controller is supplied with a plurality of NAND flash interface signals comprising a chip enable signal /CE, a command latch enable signal CLE, an address latch enable signal ALE, a reading enable signal /RE, a writing enable signal /WE, a write protect signal /WP, a ready/busy signal R/B, and input/output signals IO0˜7.

4. The integrating data processing system according to claim 1, wherein the first and second interface of the flash memory controller are supplied with a plurality of NAND flash interface signals comprising a chip enable signal /CE, a command latch enable signal CLE, an address latch enable signal ALE, a reading enable signal /RE, a writing enable signal /WE, a write protect signal /WP, a ready/busy signal R/B, and input/output signals IO0˜7.

5. The integrating data processing system according to claim 3, wherein the flash memory controller and the NAND flash memory unit are formed into a packaged chip in accordance with Land Grid Array (LGA), Thin Small Out-line Package (TSOP), or Chip on Board (COB) package standard.

6. The integrating data processing system according to claim 5, wherein the packaged chip includes 15 pins each in response to one of the plurality of NAND flash interface signals.

7. The integrating data processing system according to claim 5, wherein the packaged chip has a pin number equal to that of the NAND flash memory unit.

8. The integrating data processing system according to claim 1, wherein the master device has a NAND flash control module which is disabled when the master device is connected to the flash memory controller.

9. The integrating data processing system according to claim 1, wherein the integrating data processing system comprises a Global Positioning System (GPS), a Personal Digital Assistant (PDA), a MPEG Audio Layer III (MP3) player, and a Portable Media Player (PMP).

10. An integrating flash memory system for use with a master device with a host interface, comprising:
at lease one NAND flash memory unit for data storage, having a unit interface; and
a dual NAND flash interface memory controller for controlling access to the NAND flash memory unit, having a first interface connected to the host interface of the master device, and a second interface connected with the unit interface of the NAND flash memory unit;
wherein the dual NAND flash interface memory controller and the NAND flash memory unit are packaged into one single chip.

11. The integrating flash memory system according to claim 10, said packaged chip is in accordance with Land Grid Array (LGA), Thin Small Out-line Package (TSOP) or Chip on Board (COB) package standard.

12. The integrating flash memory system according to claim 10, wherein the first and the second interfaces of the dual NAND flash interface memory controller are supplied with a plurality of NAND flash interface signals comprising a chip enable signal /CE, a command latch enable signal CLE, an address latch enable signal ALE, a reading enable signal /RE, a writing enable signal /WE, a write protect signal /WP, a ready/busy signal R/B, and input/output signals IO0˜7.

13. The integrating flash memory system according to claim 12, wherein the packaged chip includes 15 pins each in response to one of the plurality of NAND flash interface signals.

14. The integrating flash memory system according to claim 10, wherein the packaged chip has a pin number equal to that of the flash memory unit.

15. The integrating flash memory system according to claim 10, wherein the master device has a NAND flash memory control module which is disabled when connected to the flash memory controller.

16. The integrating flash memory system according to claim 10, wherein the integrating flash memory system comprises a Global Positioning System (GPS), a Personal Digital Assistant (PDA), a MPEG Audio Layer III (MP3) player, and a Portable Media Player (PMP).

17. A NAND flash memory controller in communication between a master device having a host interface and a NAND flash memory unit having a NAND flash memory device interface, comprising:
a NAND flash memory device interface for connecting with the host interface of the master device;
a NAND flash memory host interface for connecting with the NAND flash memory device interface of the NAND flash memory unit; and
a NAND flash memory control module for controlling access to the NAND flash memory unit,
whereby the master device can access the NAND flash memory unit via the NAND flash memory control module.

18. The NAND flash memory controller according to claim 17, wherein the NAND flash memory host interface is identical to the host interface of the master device.

19. The NAND flash memory controller according to claim 17, wherein the NAND flash memory host interface is identical to the host interface of the master device and the NAND flash memory device interface of the NAND flash memory controller is identical to the NAND flash memory device interface of the NAND flash memory unit.

20. The NAND flash memory controller according to claim 17, wherein the NAND flash memory device interface of the NAND flash memory controller is supplied with a plurality of interface signals comprising a chip enable signal /CE, a command latch enable signal CLE, an address latch enable signal ALE, a reading enable signal /RE, a writing enable signal /WE, a ready/busy signal R/B, and input/output signals IO0˜n.

21. The NAND flash memory controller according to claim 17, wherein the NAND flash memory host interface is supplied with a plurality of interface signals comprising a chip enable signal /CE, a command latch enable signal CLE, an address latch enable signal ALE, a reading enable signal /RE, a writing enable signal /WE, a ready/busy signal R/B, and input/output signals IO0˜n.

22. The NAND flash memory controller according to claim 17, wherein the NAND flash memory host interface and the NAND flash memory device interface of the NAND flash memory controller are both supplied with a plurality of interface signals comprising a chip enable signal /CE, a command latch enable signal CLE, an address latch enable signal ALE, a reading enable signal /RE, a writing enable signal /WE, a ready/busy signal R/B, and input/output signals IO0˜n.
